(19) United States
(12) Patent Application Publication
(10) Pub. No.: US 2025/0159525 A1
(43) Pub. Date: May 15, 2025

(54) APPARATUS AND METHOD FOR FAST BEAM DISCOVERY

(71) Applicant: MEDIATEK INC., Hsinchu City (TW)

(72) Inventors: Yahia Ahmed Mahmoud Mahmoud SHABARA, San Jose, CA (US); Gyu Bum KYUNG, San Jose, CA (US)

(21) Appl. No.: 18/835,827

(22) PCT Filed: Jul. 28, 2023
(86) PCT No.: PCT/CN2023/109711

§ 371 Date: Aug. 5, 2024

Related U.S. Application Data
(60) Provisional application No. 63/369,771, filed on Jul. 29, 2022.

(51) Int. Cl. H04W 24/10; H04W 72/044

(52) U.S. Cl. CPC H04W 24/10; H04W 72/046

(57) ABSTRACT

A method of beam discovery can include receiving reference signals at a user equipment (UE) from a plurality of multi-armed beams of a base station (BS), each multi-armed beam including a plurality of BS narrow beams that each include an identifier and are configured to transmit signals at different angular sectors, measuring a signal quality of each of the plurality of multi-armed beams, determining a signal quality of each BS narrow beam based on at least the measured signal quality of the plurality of multi-armed beams and the respective BS narrow beam identifiers, and transmitting a reporting signal including at least an index of the signal quality corresponding to the BS narrow beams.

### INCORPORATION BY REFERENCE

This present application claims the benefit of U.S. Provisional Application No. 63/369,771, “Apparatus and Method for Fast Beam Discovery” filed on Jul. 29, 2022, which is incorporated herein by reference in its entirety.

### TECHNICAL FIELD

The present disclosure relates to wireless communications, and specifically relates to beamforming transmission and reception.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

High frequency bands (e.g., millimeter-wave band) are used to increase system capacity in wireless communication systems such as 5th generation (5G), Wi-Fi, etc. Beamforming schemes can be employed to focus transmitted and/or received signals in a desired direction to compensate for path loss of high frequency signals.

### SUMMARY

Aspects of the disclosure provide a method of beam discovery. The method can include receiving reference signals at a user equipment (UE) from a plurality of multi-armed beams of a base station (BS), each multi-armed beam including a plurality of BS narrow beams that each include an identifier and are configured to transmit signals at different angular sectors, measuring a signal quality of each of the plurality of multi-armed beams, determining a signal quality of each BS narrow beam based on at least the measured signal quality of the plurality of multi-armed beams and the respective BS narrow beam identifiers, and transmitting a reporting signal including at least an index of the signal quality corresponding to the BS narrow beams.

In an embodiment, the reference signals are measurement reference signals that include the identifiers of the plurality of BS narrow beams.

In an embodiment, the plurality of multi-armed beams is configured according to a predefined error-correcting code. In an example, a number of multi-armed beams is N, a number of BS narrow beams is M, and the plurality of multi-armed beams is configured according to a N×M binary parity check matrix H of the predefined error-correcting code, wherein each row corresponding to one multi-armed beam, each column corresponding to one angular sector, and a plurality of Is in the binary parity check matrix H corresponding to the narrow beams included in each multi-armed beam.

In an example, the reference signals are configured based on at least the parity check matrix H. In an example, the determining a signal strength of each BS narrow beam can further include constructing an error syndrome having a form of m=H×h, where m is a N×1 matrix with each row being at least the measured signal quality of each respective multi-armed beam, H is the N X M binary parity check matrix, and h is a M×1 matrix with each row representing the signal quality of the respective BS narrow beams, and determining the matrix h by solving the error syndrome.

In an embodiment, the method can further include receiving additional reference signals including at least an index of the signal quality corresponding to a plurality of UE narrow beams.

Aspects of the disclosure provide an apparatus. The apparatus includes circuitry configured to receive reference signals at a UE from a plurality of multi-armed beams of a BS, each multi-armed beam including a plurality of BS narrow beams that each include an identifier and are configured to transmit signals at different angular sectors, measure a signal quality of each of the plurality of multi-armed beams, determine a signal quality of each BS narrow beam based on at least the measured signal quality of the plurality of multi-armed beams and the respective BS narrow beam identifiers, and transmit a reporting signal including at least an index of the signal quality corresponding to the BS narrow beams.

Aspects of the disclosure provide a non-transitory computer-readable medium storing instructions that, when executed by a processor, cause the processor to perform the method.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a beam-based wireless communication system 100 according to an embodiment of the disclosure.

FIG. 2 shows multiple multi-armed beams 210-240 according to embodiments of the present disclosure.

FIG. 3A shows a wireless communication system 400 including a UE 301 and a BS 302.

FIGS. 3B-3C show various examples of angular sector configurations by the BS 302.

FIG. 4 shows a process 400 according to an embodiment of the disclosure.

FIG. 5 shows an exemplary apparatus 500 according to embodiments of the disclosure.

### DETAILED DESCRIPTION OF EMBODIMENTS

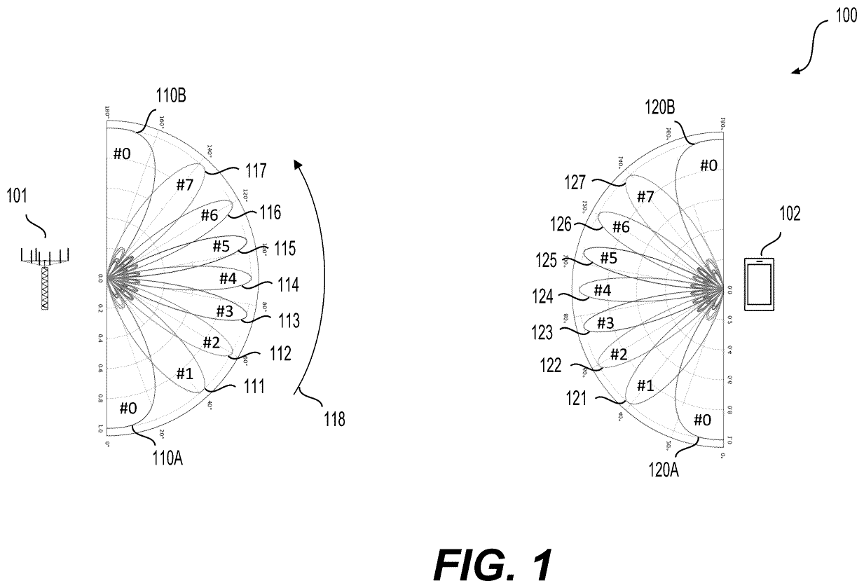

FIG. 1 shows a beam-based wireless communication system 100 according to an embodiment of the disclosure. The system 100 can include a base station (BS) 101 and user equipment (UE) 102. The system 100 can employ the 5th generation (5G) technologies developed by the 3rd Generation Partnership Project (3GPP). For example, millimeter Wave (mm-Wave) frequency bands and beamforming technologies can be employed in the system 100. Accordingly, the BS 101 and the UE 102 can perform beamformed transmission or reception. In beamformed transmission, wireless signal energy can be focused on a specific direction (e.g., angular sector) to cover a target serving region. As a result, an increased antenna transmission (Tx) gain can be achieved in contrast to omnidirectional antenna transmission. Similarly, in beamformed reception, wireless signal energy received from a specific direction can be combined to obtain a higher antenna reception (Rx) gain in contrast to omnidirectional antenna reception. The increased Tx or Rx gain can compensate path loss or penetration loss in mm-Wave signal transmission.

The BS 101 can be a base station implementing a gNB node as specified in new radio (NR) air interface standards being developed by 3GPP. The BS 101 can be configured to control one or more antenna arrays, referred to as transmission reception points (TRPs), to form directional Tx or Rx beams for transmitting or receiving wireless signals. In FIG. 1 example, the BS 101 can use one or more TRPs to form 8 Tx or Rx beams 110-117 to cover a cell. Each of the beams 110-117 can be generated towards different directions simultaneously or in different time intervals. The beam 110 includes two half sections 110A and 110 B that combines to be one single direction. In one example, the BS 101 is configured to perform a beam sweeping 118 to transmit control channel and/or data channel signals. During the beam sweeping 118, Tx beams 110-117 towards different directions can be successively formed in a time division multiplex (TDM) manner to cover the cell. During each time interval for transmission of one of the Tx beams 110-117, a set of control channel data and/or data channel data can be transmitted. The beam sweeping 118 can be performed repeatedly with a certain periodicity.

The UE 102 can be a user equipment such as a mobile phone, a laptop computer, a vehicle carried mobile communication device, and the like, or a base station. Similarly, the UE 102 can employ one or more antenna arrays to generate directional Tx or Rx beams 120-127 for transmitting or receiving wireless signals.

With beam-based wireless communication, beam alignment between the BS 101 and UE 102 is required at the initial stage to form a suitable communication path that can compensate for path loss and penetration loss in mm-Wave transmission. In one example, the BS 101 is configured to perform a beam sweeping 118 to transmit reference signals using the Tx or Rx beams 110-117 to cover the entire angular space of the transmit sector. The UE 102 measures every reference signal received and reports the best reference signal index to the BS 101 for data transmission. The BS 101 can deploy a multi-stage operation to reduce resource usage during initial beam alignment. For example, the 3GPP specification of release 15 specifies a 3-phase operation that requires the BS 101 to transmit synchronization signal blocks that utilize SSB beams for beam sweeping 118 in the first stage. The SSB beams can cover larger sectors compared to narrow beams. For example, an SSB beam can cover the sectors covered by beams 112-114. The UE 102 measures all SSB beams and reports the best SSB index to the BS 101. In the second stage, the BS 101 transmits channel station information reference signals (CSI-RS) using only the narrow beams covered by the best SSB beam. The UE 102 measures and reports the index of the best CSI-RS and the reference signal received power (RSRP) of the best CSI-RS (e.g., the best BS narrow beams or a preferred BS narrow beam having a quality above a threshold). In the third stage, if the UE 102 is equipped with multiple UE narrow beams and is beamforming capable, the BS 101 transmits the same CSI-RS resource using the determined best BS narrow beam at the second stage for the UE 102 to find the best UE narrow beam (or a preferred UE narrow beam having a quality above a threshold). To further reduce the time and resources used for beam alignment, a multi-armed beam structure is presented in the present disclosure. The multi-armed beams can be configured by the BS or the UE for signal transmission or reception.

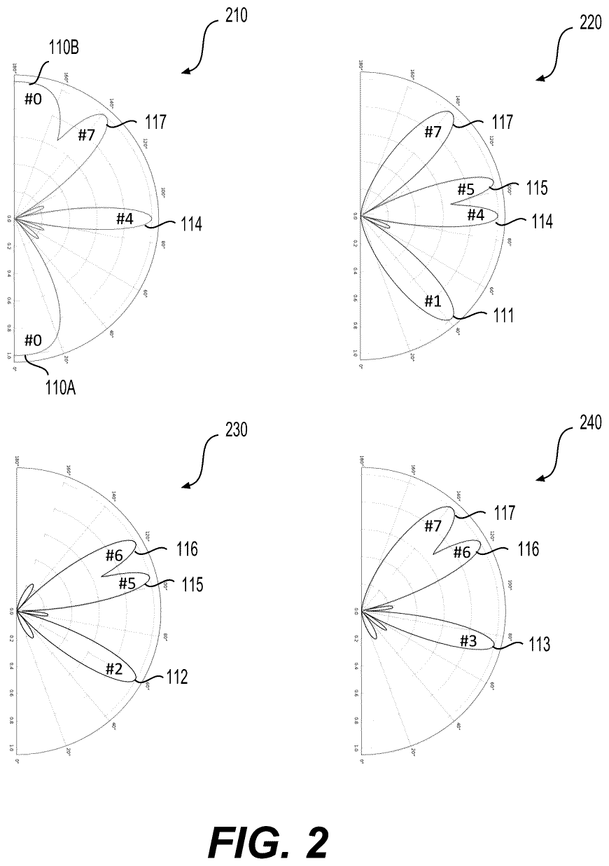

FIG. 2 shows multiple multi-armed beams 210-240 according to embodiments of the present disclosure. Each multi-armed beam 210-240 can simultaneously probe multiple directions for signal reception and results in one measurement at the receiver. The result of each measurement can reveal the combined strength of the path within the measured directions. However, this creates ambiguity as to which direction(s) contain the strongest path(s). Therefore, by creating multiple multi-armed beams with different angular combinations can resolve the ambiguity issue. In addition, one multi-armed beam can have narrow beams overlapping with other narrow beams within another multi-armed beam. For example, the multi-armed beams 210 and 220 includes the same narrow beam 114 and 117. For another example, the multi-armed beams 210 and 230 do not include narrow beams that overlap. The multi-armed beam structure can be deployed at the base station or the UE for signal transmission or reception.

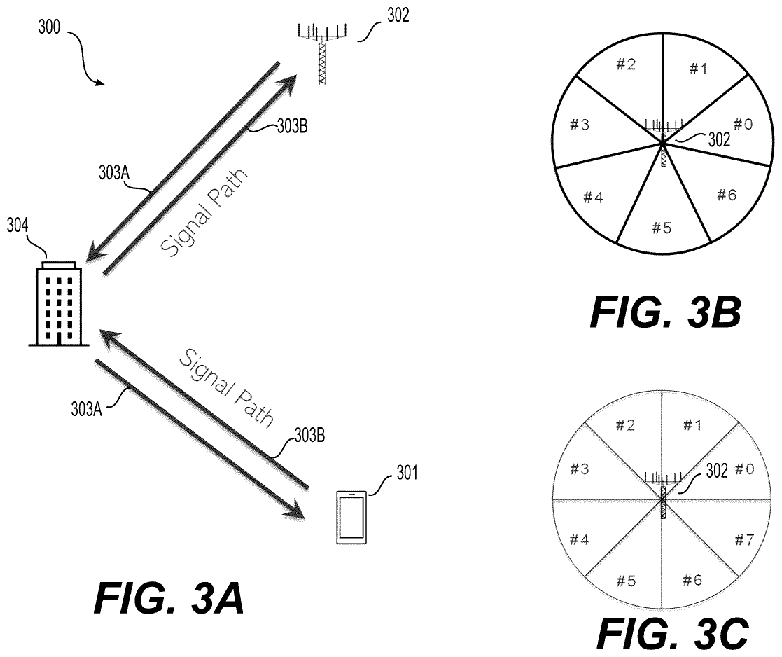

FIG. 3A shows a wireless communication system 400 including a UE 301 and a BS 302. FIGS. 3B-3C show various examples of angular sector configurations of the BS 302. The BS 302 can divide the angular directions needed for signal transmission into multiple angular sectors, each can be covered by one narrow beam (e.g., the narrow beams 110-117 shown in FIG. 1). The angular sectors can be configured dynamically or configured by a fixed configuration. FIG. 3B shows a BS 302 having 7 angular sectors #0-#6 that are dynamically configured according to the configuration of the measurement. FIG. 3C shows a BS 302 having 8 angular sectors #0-#7 that are fixed in number. The details of various configurations of the angular sectors are discussed below. The system 400 can include an object 304. A BS 302 can transmit signals that can be reflected on an object 304. The object 304 can be a building, a vehicle, a relay object, or the like. Measurement reference signals (MRS), such as synchronization signal block (SSB) or channel state information RS (CSI-RS) can be transmitted from the BS 302 to the UE 301. For example, SSB or CSI-RS transmitted from the BS 302 can follow a signal path 303A to reach the UE 301. The UE 301 can deploy multiple multi-armed beams to receive the MRS. For example, the UE 301 can deploy multi-armed beams 210-240 as shown in FIG. 2. The UE 301 can transmit the measurement results of the received MRS back to the BS 302. The measurement results can include the best BS narrow beam(s) that is determined by the UE 301. The measurement results can also be the raw measurements of the received signals for the BS 302 to determine the best BS narrow beam(s) at the BS side.

The specific number of the multi-armed beams and the configurations of each multi-armed beam (i.e., the narrow beams included to cover multiple angular sectors) for signal transmission can be determined by considering the channels of the angular sectors as a vector

$${h}^{a} = ( \begin{matrix}{h}_{0}^{a} \\ {h}_{1}^{a} \\ ⋮ \\ {h}_{M - 1}^{a}\end{matrix} ) ,$$

where M is the number of angular directions and the maximum number of discoverable channel paths. The channel vector can be considered as a channel encoded binary information sequence, where the strong component can be represented by 1 and the small components can be represented by 0. An error syndrome of the channel code having a form of m_{b}=Hh_{b}^{a} can be constructed at the UE side for determining the channel vector, where m_{b} is a N×1 matrix representing N numbers of measurements (e.g., N numbers of the multi-armed beams), H is a parity check matrix corresponding to a channel code [symbol] (n, k) where n is the code length and k is the number of the data bits, and b represents the vector is being considered as binary form.

The code length n of the channel code C(n, k) can be considered as the number of angular directions covered by the BS 302. The parity check bits n−k of the channel code C(n, k) can be considered as the number of measurements (e.g., the number of multi-armed beams) required for the UE 301 to determine the individual signal quality of the BS narrow beams. The BS 302 can transmit the parity check matrix H in MRS to the UE 301 for decoding the channel vector. By considering the h_{b}^{a} as an error sequence, a one-to-one mapping between h_{b}^{a} and m_{b} can be determined. Therefore, by knowing the parity check matrix H, the UE 301 can mimic the error syndrome having a form of m=Hh^{a}, which can result in a one-to-one mapping between the complex-valued measurement m and the channel h^{a}.

In an embodiment of the present disclosure, the BS 302 can design the multi-armed beams according to a parity check matrix of a suitable channel code C. According to various aspects of the channel environment, the BS 302 can configure the multi-armed beams dynamically. For example, the BS 302 can determine the channel code C according to certain environment restrictions or network selections. By determining the channel code C dynamically, the BS 302 can configure the angular sections dynamically as shown in FIG. 3B. For example, hamming code (7,4) can be chosen for the BS 302 to configure the multi-armed beams for signal transmission. The number of angular directions needed is 7, and the total number of measurements needed to decode the code is 4. The parity bits needed for the hamming code (7,4) equals to n−k, which yields to 3 parity bits. A parity check matrix H can be constructed based on the hamming code (7,4) by determining the generator matrix G of the hamming code (7,4) first. The generator matrix is a matrix whose rows form a basis for a linear code. The parity check matrix H must satisfy HG^{T}=0, where G^{T} is the transpose of matrix G. The parity check matrix H is a (n−k)×n matrix (e.g., a 3×7 matrix). The parity check matrix H of a given error-correcting code needs to satisfy at least linear independence, full rank, and orthogonality. The parity check matrix H also needs to describe the linear relations that the components of a codeword of the chosen code must satisfy. Therefore, for a given error-correcting code, there may exists multiple valid parity check matrix H. For an example, hamming code (7,4) can have a parity check matrix

$${H}_{7 , 4} = ( \begin{matrix}1 & 1 & 0 & 1 & 1 & 0 & 0 \\ 1 & 0 & 1 & 1 & 0 & 1 & 0 \\ 0 & 1 & 1 & 1 & 0 & 0 & 1\end{matrix} ) .$$

For another example, hamming code (7,4) can have a parity check matrix

$${H}_{7 , 4} = ( \begin{matrix}1 & 0 & 1 & 0 & 1 & 0 & 1 \\ 0 & 1 & 1 & 0 & 0 & 1 & 1 \\ 0 & 0 & 0 & 1 & 1 & 1 & 1\end{matrix} ) .$$

The specific parity check matrix H can be constructed to meet certain measurement requirements of the channel being utilized by the BS and UE.

In an embodiment of the present disclosure, hamming code (8,4) which is a non-standard extended version of hamming code (7,4) can be used for the BS 302 to configure the multi-armed beams in the case of a fixed angular sector setup as shown in FIG. 3C. The UE 301 can have a fixed angular configuration includes angular sectors #0-#7. By choosing the hamming code (8,4), it can satisfy the physical requirement of the BS 302. The hamming code (8,4) can be modified from hamming code (7,4) by adding an extra parity bit. For example, a parity check matrix H_{8,4} can have a form of

$${H}_{8 , 4} = ( \begin{matrix}1 & 0 & 0 & 0 & 1 & 0 & 0 & 1 \\ 0 & 1 & 0 & 0 & 1 & 1 & 0 & 1 \\ 0 & 0 & 1 & 0 & 0 & 1 & 1 & 0 \\ 0 & 0 & 0 & 1 & 0 & 0 & 1 & 1\end{matrix} )$$

which can be used to construct the multi-armed beams of the BS 302. For example, the BS 302 can use the determined parity check matrix H_{8,4} to construct the multi-armed beams for signal reception and measurement. Referring to FIG. 2, the multi-armed beams 210-240 are constructed according to the parity check matrix H_{8,4}. The multi-armed beam 210 covering angular sectors #0, #4, and #7, the multi-armed beam 220 covering angular sectors #1, #4, #5, and #7, the multi-armed beam 230 covering angular sectors #2, #5, and #6, and the multi-armed beam 240 covering angular sectors #3, #6, and #7.

In an embodiment, the BS 302 and the UE 301 can perform a downlink beam measurement process utilizing the multi-armed beam structure in order to select a BS narrow beam (e.g., narrow beams 110-117 in FIG. 1) and a UE narrow beam (e.g., narrow beams 120-127 in FIG. 1) for downlink transmission. For example, multiple beam pairs exist between the BS 302 and the UE 301. Each beam pair can include one of the BS narrow beams 110-117 and one of the UE narrow beams 120-127. However, for a certain environment of the BS and the UE, different beam pair links may have different qualities. Based on the beam measurement process, for example, a beam pair link with a highest quality can be selected, or a beam pair link with a quality above a threshold can be selected with considerations of other factors.

Specifically, during the beam measurement process, the BS 302 can repeat beam sweepings for a number of times equal to a number of UE multi-armed beams. During each beam sweeping, the BS 302 can utilize multi-armed beams including the BS narrow beams 110-117 to cover the cell. Each of the BS multi-armed beam, when transmitted, can carry a measurement reference signal (MRS), e.g., synchronization signal block (SSB) or channel state information RS (CSI-RS). The configuration of the multi-armed beams used by the BS 302 such as the parity check matrix H can be included in the MRS. The UE 301 can employ the MRS to compute one or more quality measurements, such as a signal-to-noise ratio (SNR) related metric, SINR related metric, reference signal received power (RSRP), or a reference signal received quality (RSRQ) for the respective multi-armed beams, or a complex channel gain quantity. The UE 301 can then compute a best BS narrow beam (or a set of preferred BS narrow beam having a quality above a threshold) by solving error syndromes with the measurements and the received H.

The UE 301 can then report the determined best BS narrow beam (or a set of preferred BS narrow beams having a quality above a threshold) and other beam quality measurements back to the BS 302. The BS 302 can utilize similar steps to determine the best UE narrow beam (or a set of preferred UE narrow beams having a quality above a threshold). Accordingly, a best BS narrow beam and a best UE narrow beam (or a best set of BS narrow beams and a best set of UE narrow beams) can accordingly be determined and known to the UE 301 and the BS 302.

After the best BS narrow beam(s) is determined at the UE 301, the UE 301 can report the measurement results to the BS 302. For example, the UE 301 can inform the BS 302 of the determined best BS narrow beam(s). For example, the MRSs can each be associated with a set of BS narrow beam indexes. In some examples, a measurement report including the computed quality measurements can be provided to the BS 302 from the UE 301. In another example, each BS narrow beam is associated to one or one set of PRACH resources, which is informed to the UE 301 through the system information. The BS 302 derives the best BS narrow beam information according to the received PRACH.

In an embodiment of the present disclosure, the UE 301 can transmit the raw measurement results of the received signal back to the BS 302 without computing the best BS narrow beam(s). The BS 302 can determine the best BS narrow beam(s) according to the configuration of the BS multi-armed beams and the reported measurements. For example, the BS 302 can determine the best BS narrow beam(s) by solving the error syndrome with the parity check matrix H. The BS 302 can also compute the best UE narrow beam(s) utilizing the signal sent from the UE 301 that includes the raw measurement results. The BS 302 can then transmit the best BS narrow beam(s) (if needed) and the best UE narrow beams back to the UE 301. Accordingly, the best BS narrow beam(s) and the best UE narrow beam(s) can be known to the UE 301 and the BS 302.

For uplink transmission, a similar beam measurement process and reporting process can be performed to determine a best UE narrow beam and a best BS narrow beam. For example, the UE 301 can utilize multi-armed beams including the BS narrow beams 120-127 as shown in FIG. 1 to cover the cell. During each beam sweeping of the UE 301, the BS 302 can use one of the BS narrow beams to receive uplink transmissions. Reference signals including information of the parity check matrix H or other configuration information can be transmitted by the UE multi-armed beams to calculate beam pair link quality measurements. Based on the quality measurements, a best UE narrow beam can be determined at the BS 301. The BS 302 can then report the best UE narrow beam to the UE 301 for the UE 301 to compute the best BS narrow beam. By successively performing the above downlink and uplink beam measurement and report processes, the best UE narrow beams and the best BS narrow beams for both transmission and reception can be known at both the BS 110 and UE 120.

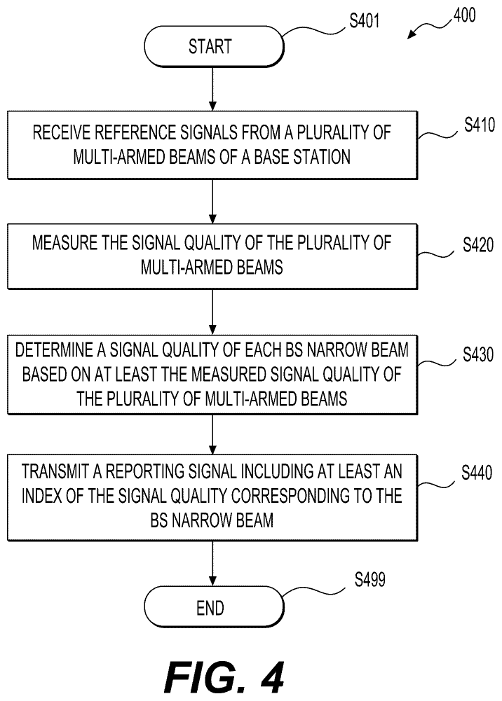

FIG. 4 shows a process 400 according to an embodiment of the disclosure. The process 400 can start from S401 and proceed to S410.

At S410, a user equipment (UE) receives reference signals from a plurality of multi-armed beams of a base station (BS). Each multi-armed beam can include a plurality of BS narrow beams that each include an identifier and are configured to transmit signals at different angular sector. For example, the multi-armed beams and the configuration of the BS narrow beams within each multi-armed beam can be constructed by the BS by choosing a suitable error correcting code C(n, k), where n is the code length and k is the data bits. By determining the generator matrix of the error correcting code, the BS can construct a parity check matrix H of the error correcting code. The parity check matrix H is a N×M matrix, where N=n−k represents the number of multi-armed beams and M=n represents the number of BS narrow beams. The BS can construct the multi-armed beams according to the physical restrictions such as a fixed configuration of the angular sectors of the BS. The BS can construct the multi-armed beams dynamically. In an example, the BS can construct the multi-armed beams according to the network environment. In an example, the BS can deploy machine learning to find the suitable error correcting code and/or the parity check matrix to adapt to the network environment.

At S420, a UE measures the signal quality of the plurality of multi-armed beams. For example, the UE can measure the signal received using a signal-to-noise ratio (SNR) related metric, a SINR related metric, a reference signal received power (RSRP), or a reference signal received quantity (RSRQ) or a complex-valued channel gain quantity.

At S430, a UE determines a signal quality of each BS narrow beam based on at least the measured signal quality of the plurality of multi-armed beams. The UE also determines the respective BS narrow beam identifiers. For example, the UE can compute the signal qualities of the BS narrow beams by applying an error syndrome having a form of m=H×h, where m is a vector of the measured signal qualities of the multi-armed beams, H is the parity check matrix received from the BS along with the reference signal, and h is a vector of the signal qualities of the BS narrow beams.

At S440, a UE transmits a reporting signal including at least an index of the signal quality corresponding to the BS narrow beams. The process 400 can proceed to S499, and terminate at S499.

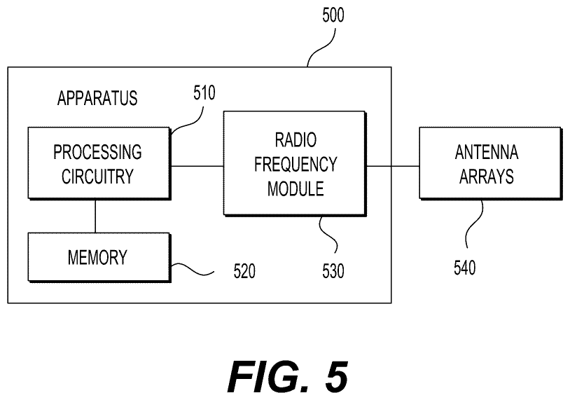

FIG. 5 shows an exemplary apparatus 500 according to embodiments of the disclosure. The apparatus 500 can be configured to perform various functions in accordance with one or more embodiments or examples described herein. Thus, the apparatus 500 can provide means for implementation of mechanisms, techniques, processes, functions, components, systems described herein. For example, the apparatus 500 can be used to implement functions of UEs or BSs in various embodiments and examples described herein. The apparatus 500 can include a general purpose processor or specially designed circuits to implement various functions, components, or processes described herein in various embodiments. The apparatus 500 can include processing circuitry 510, a memory 520, and a radio frequency (RF) module 530.

In various examples, the processing circuitry 510 can include circuitry configured to perform the functions and processes described herein in combination with software or without software. In various examples, the processing circuitry 510 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 510 can be a central processing unit (CPU) configured to execute program instructions to perform various functions and processes described herein. Accordingly, the memory 520 can be configured to store program instructions. The processing circuitry 510, when executing the program instructions, can perform the functions and processes. The memory 520 can further store other programs or data, such as operating systems, application programs, and the like. The memory 520 can include non-transitory storage media, such as a read only memory (ROM), a random access memory (RAM), a flash memory, a solid state memory, a hard disk drive, an optical disk drive, and the like.

In an embodiment, the RF module 530 receives a processed data signal from the processing circuitry 510 and converts the data signal to beamforming wireless signals that are then transmitted via antenna arrays 540, or vice versa. The RF module 530 can include a digital to analog converter (DAC), an analog to digital converter (ADC), a frequency up converter, a frequency down converter, filters and amplifiers for reception and transmission operations. The RF module 530 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 540 can include one or more antenna arrays.

The apparatus 500 can optionally include other components, such as input and output devices, additional or signal processing circuitry, and the like. Accordingly, the apparatus 500 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method of beam discovery, comprising:
receiving reference signals at a user equipment (UE) from a plurality of multi-armed beams of a base station (BS), each multi-armed beam including a plurality of BS narrow beams that each include an identifier and are configured to transmit signals at different angular sectors;
measuring a signal quality of each of the plurality of multi-armed beams;
determining a signal quality of each BS narrow beam based on at least the measured signal quality of the plurality of multi-armed beams and the respective BS narrow beam identifiers; and
transmitting a reporting signal including at least an index of the signal quality corresponding to the BS narrow beams.

2. The method of claim 1, wherein the reference signals are measurement reference signals that include the identifiers of the plurality of BS narrow beams.

3. The method of claim 1, wherein the plurality of multi-armed beams is configured according to a predefined error-correcting code.

4. The method of claim 2, wherein a number of multi-armed beams is N, a number of BS narrow beams is M, and the plurality of multi-armed beams is configured according to a N×M binary parity check matrix H of the predefined error-correcting code, wherein each row corresponding to one multi-armed beam, each column corresponding to one angular sector, and a plurality of Is in the binary parity check matrix H corresponding to the narrow beams included in each multi-armed beam.

5. The method of claim 4, wherein the reference signals are configured based on at least the parity check matrix H.

6. The method of claim 4, wherein the determining a signal quality of each BS narrow beam further comprises:
constructing an error syndrome having a form of m=H×h, where m is a N×1 matrix with each row being at least the measured signal quality of each respective multi-armed beam, H is the N×M binary parity check matrix, and h is a M×1 matrix with each row representing the signal quality of the respective BS narrow beams; and
determining the matrix h by solving the error syndrome.

7. The method of claim 1, further comprises:
receiving additional reference signals including at least an index of the signal quality corresponding to a plurality of UE narrow beams.

8. An apparatus, comprising circuitry configured to:
receive reference signals at a user equipment (UE) from a plurality of multi-armed beams of a base station (BS), each multi-armed beam including a plurality of BS narrow beams that each include an identifier and are configured to transmit signals at different angular sectors;
measure a signal quality of each of the plurality of multi-armed beams;
determine a signal quality of each BS narrow beam based on at least the measured signal quality of the plurality of multi-armed beams and the respective BS narrow beam identifiers; and
transmit a reporting signal including at least an index of the signal quality corresponding to the BS narrow beams.

9. The apparatus of claim 8, wherein the reference signals are measurement reference signals that include the identifiers of the plurality of BS narrow beams.

10. The apparatus of claim 8, wherein the plurality of multi-armed beams is configured according to a predefined error-correcting code.

11. The apparatus of claim 9, wherein a number of multi-armed beams is N, a number of BS narrow beams is M, and the plurality of multi-armed beams is configured according to a N×M binary parity check matrix H of the predefined error-correcting code, wherein each row corresponding to one multi-armed beam, each column corresponding to one angular sector, and a plurality of Is in the binary parity check matrix H corresponding to the narrow beams included in each multi-armed beam.

12. The apparatus of claim 11, wherein the reference signals are configured based on at least the parity check matrix H.

13. The apparatus of claim 11, wherein the circuitry is further configured to:
construct an error syndrome having a form of m=H×h, where m is a N×1 matrix with each row being at least the measured signal quality of each respective multi-armed beam, H is the N×M binary parity check matrix, and h is a M×1 matrix with each row representing the signal quality of the respective BS narrow beams; and
determine the matrix h by solving the error syndrome.

14. The apparatus of claim 8, wherein the circuitry is further configured to:
receive additional reference signals including at least an index of a best UE narrow beam.

15. A non-transitory computer-readable medium storing instructions that, when executed by a processor, cause the processor to perform a method, the method comprising:
receiving reference signals at a user equipment (UE) from a plurality of multi-armed beams of a base station (BS), each multi-armed beam including a plurality of BS narrow beams that each include an identifier and are configured to transmit signals at different angular sectors;
measuring a signal quality of each of the plurality of multi-armed beams;
determining a signal quality of each BS narrow beam based on at least the measured signal quality of the plurality of multi-armed beams and the respective BS narrow beam identifiers; and
transmitting a reporting signal including at least an index of the signal quality corresponding to the BS narrow beams.

16. The non-transitory computer-readable medium of claim 15, wherein the reference signals are measurement reference signals (MRS) that include the identifiers of the plurality of BS narrow beams.

17. The non-transitory computer-readable medium of claim 15, wherein the plurality of multi-armed beams is configured according to a predefined error-correcting code.

18. The non-transitory computer-readable medium of claim 16, wherein a number of multi-armed beams is N, a number of BS narrow beams is M, and the plurality of multi-armed beams is configured according to a N×M binary parity check matrix H of the predefined error-correcting code, wherein each row corresponding to one multi-armed beam, each column corresponding to one angular sector, and a plurality of 1s in the binary parity check matrix H corresponding to the narrow beams included in each multi-armed beam.

19. The non-transitory computer-readable medium of claim 18, wherein the reference signals are configured based on at least the parity check matrix H.

20. The non-transitory computer-readable medium of claim 18, wherein the method further comprises:
constructing an error syndrome having a form of m=H×h, where m is a N×1 matrix with each row being at least the measured signal quality of each respective multi-armed beam, H is the N×M binary parity check matrix, and h is a M×1 matrix with each row representing the signal quality of the respective BS narrow beams; and
determining the matrix h by solving the error syndrome.
